(19) United States
(12) Patent Application Publication
(10) Pub. No.: US 2007/0202378 A1
(43) Pub. Date: Aug. 30, 2007

(54) Integrated micro fuel cell apparatus

(76) Inventors: John J. D'Urso, Chandler, AZ (US); Jeffrey H. Baker, Chandler, AZ (US); Chowdary R. Koripella, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/363,790

(22) Filed: Feb. 28, 2006

(51) Int. Cl. H01M 8/02; H01M 8/10

(52) U.S. Cl. 429/34; 429/33; 429/38

(57) ABSTRACT

A micro fuel cell and method of forming such includes depositing multiple layers (22) of alternating metals over a substrate (12); etching at least one metal from the multiple layers (22) creating a void between the remaining layers; forming a plurality of pedestals (28) in the multiple layers (22), each pedestal (28) having a center anode (29) portion and a concentric cathode (31) portion separated by a concentric cavity (31); filling the concentric cavity (31) with an electrolyte; and capping the center anode (29) portion and the concentric cavity (31).

### FIELD OF THE INVENTION

The present invention generally relates to micro fuel cells, and more particularly to a micro fuel cell apparatus integrated on silicon.

### BACKGROUND OF THE INVENTION

Rechargeable batteries are the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. It could last for a few hours to a few days depending on the usage. Recharging always requires an electrical outlet. The limited amount of stored energy and the frequent recharging are major inconveniences with the batteries. There is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatt's, and it requires a large volume to generate sufficient power in the hundred of milliwatts needed, making it unattractive for cell phone type applications.

An alternative approach is to carry a high energy density fuel and convert this fuel energy into electrical energy with high efficiency to recharge the battery. Radioactive isotope fuels with high energy density are being investigated for portable power sources. However, the power densities are low with this approach, and also there are safety concerns with the radioactive materials. This is an attractive power source for remote sensor type applications, but not for cell phone power sources. Among the various other energy conversion technologies, the most attractive one is the fuel cell technology because of its high efficiency of energy conversion and the demonstrated feasibility to miniaturize with high efficiency.

Fuel cells with active control systems and high operating temperature fuel cells such as active control direct methanol or formic acid fuel cells (DMFC or DFAFC), reformed hydrogen fuel cells (RHFC) and solid oxide fuel cells (SOFC) are complex systems and very difficult to miniaturize to the 2-5 cc volume needed for cell phone application. Passive air breathing hydrogen fuel cells, passive DMFC or DFAFC, and biofuel cells are attractive systems for this application. However, in addition to the miniaturization issues, other concerns include supply of hydrogen for hydrogen fuel cells, life time and energy density for passive DMFC and DFAFC, and life time, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and passage of fuel and an oxidant along and between cells. Additionally, the planar, stacked cells derive power only from a fuel/oxidant interchange in a cross sectional area (x and y coordinates).

To design a fuel cell/battery hybrid power source in the same volume as the current cell phone battery (10 cc-2.5 Wh), a smaller battery and a fuel cell with high power density and efficiency would be required to achieve an overall energy density higher than that of the battery alone. For example, for a 4-5 cc (1-1.25 Wh) battery to meet the peak demands of the phone, the fuel cell would need to fit in 1-2 cc, with the fuel taking up the rest of the volume. The power output of the fuel cell needs to be 0.5 W or higher to be able to recharge the battery in a reasonable time. Most development activities on small fuel cells are attempts to miniaturize the traditional fuel cell designs into a small scale, and the resultant systems are still too big for cell phone application. A few micro fuel cell development activities have been disclosed using traditional silicon processing methods in planar fuel cell configurations, and in few cases using porous silicon (to increase the surface area and power densities). See for example, U.S. Pat./Application Nos. 2004/0185323, 2004/0058226, 6,541,149, and 2003/0003347. However, the power densities of the air breathing planar hydrogen fuel cells are typically in the range of 50-100 mW/cm². To produce 500 mW, it would require 5 cm² or more active area. The operating voltage of a single fuel cell is in the range of 0.5-0.7V. At least four to five cells need to be connected in series to bring the fuel cell operating voltage to 2-3V for efficient DC-DC conversion to 4V in order to charge the Li ion battery. Therefore, the traditional planar fuel cell approach will not be able to meet the requirements in 1-2 cc volume for a fuel cell in the fuel cell/battery hybrid power source for cell phone use.

Accordingly, it is desirable to provide a micro fuel cell apparatus integrated on silicon, glass, ceramic or polymer substrates that derive power from a three dimensional fuel/oxidant interchange. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A micro fuel cell and method of forming such includes depositing multiple layers of alternating metals over a substrate; etching at least one metal from the multiple layers creating a void between the remaining layers; forming a plurality of pedestals in the multiple layers, each pedestal having a center anode portion and a concentric cathode portion separated by a concentric cavity; filling the concentric cavity with an electrolyte; and capping the center anode portion and the concentric cavity.

### BRIEF DESCRIPTION OF THE DRAWINGS

The present invention will hereinafter be described in conjunction with the following drawing figures, wherein like numerals denote like elements, and

FIGS. 1-9 are partial cross sectional views showing the layers as fabricated in accordance with an exemplary embodiment of the present invention; and

FIG. 10 is a partial cross sectional top view of FIG. 9;

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

Main components of a micro fuel cell device are a proton conducting electrolyte separating the reactant gases on the anode and cathode regions, an electrocatalyst which helps in the oxidation and reduction of the gas species at the anode and cathode regions of the fuel cell, a gas diffusion layer to provide uniform reactant gas access to anode and cathode regions, and a current collector for efficient collection of electrons and transport them to a load connected across the fuel cell. In the fabrication of the micro fuel cell structures, conductive porous metal layers can be used for gas diffusion as well as for current collection. A process is described herein to make these porous metal layers suitable for micro fuel cell and the processing of a micro fuel cell structure using these porous metal layers.

Fabrication of individual micro fuel cells inside high aspect ratio micro pores provides a high surface area for proton exchange between a fuel (anode) and an oxidant (cathode). At these small dimensions, precise alignment of anode, cathode, electrolyte and current collectors is required to prevent shorting of the cells. This alignment may be accomplished by semiconductor processing methods used in the integrated circuit processing. Functional cells may also be fabricated in ceramic, glass or polymer substrates.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing comprises fuel cells with required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Multiple metallic conductors are used as the anode and cathode for gas diffusion and also for current collection. An electrocatalyst is deposited on the walls of the multiple layers that are in contact with the electrolyte. A proton conducting electrolyte is contained within the cavities. At such small dimensions, surface tension holds the liquid electrolyte inside the cavities; however, it may be capped on the top.

In the 3D micro fuel cell design, of the exemplary embodiment, with thousands of micro fuel cells connected in parallel, the current carried by each cell is small. In case of failure in one cell, it will cause only a small incremental increase in current carried by the other cells in the parallel stack without detrimentally affecting their performance.

FIGS. 1-9 illustrate an exemplary process to fabricate fuel cells with a semiconductor process on silicon, glass or a ceramic substrate. Referring to FIG. 1, a thin layer 14 of titanium is deposited on a substrate 12 to provide adhesion for subsequent metallization layers and may also be an electrical back plane (for I/O connections, current traces). The layer 14 may have a thickness in the range of 10-1000 Å, but preferably is 100 Å. Metals other than titanium may be used, e.g., tantalum, molybdenum, tungsten, chromium. A first metal layer 16, e.g., gold, is deposited on the layer 14 for good conduction and also since it is a noble metal more suitable in the oxidizing reducing atmospheres seen during the operation of the fuel cell.

Referring to FIG. 2, the gold layer 16 is then patterned and etched for providing contacts to elements described hereinafter (alternatively, a lift off process could be used), and an oxide layer 18 is deposited thereon. A second metal layer 20, e.g., gold, is deposited on the layer 18 and patterned and etched for providing contacts to elements described hereinafter. The layer 16 may have a thickness in the range of 100 Å-1 um, but preferably is 1000 Å. Metals for the first and second metal layers other than gold, may include, e.g., platinum, silver, palladium, ruthenium, nickel, copper. A via 15 is then created and filled with metal to bring the electrical contact of gold layer 16 to the surface 19 of dielectric layer 18.

Referring to FIG. 3, multiple layers 22 comprising alternating conducting material layer, e.g., metals such as silver/gold, copper/silver, nickel/copper, copper/cobalt, nickel/zinc and nickel/iron, and having a thickness in the range of 100-500 um, but preferably 200 um (with each layer having a thickness of 0.1 to 10 micron, for example, but preferably 0.1 to 1.0 microns), are deposited on the metal layer 20 and a seed layer (not shown) above oxide layer 18. A dielectric layer 24 is deposited on the multiple layers 22 and a resist layer 26 is patterned and etched on the dielectric layer 24.

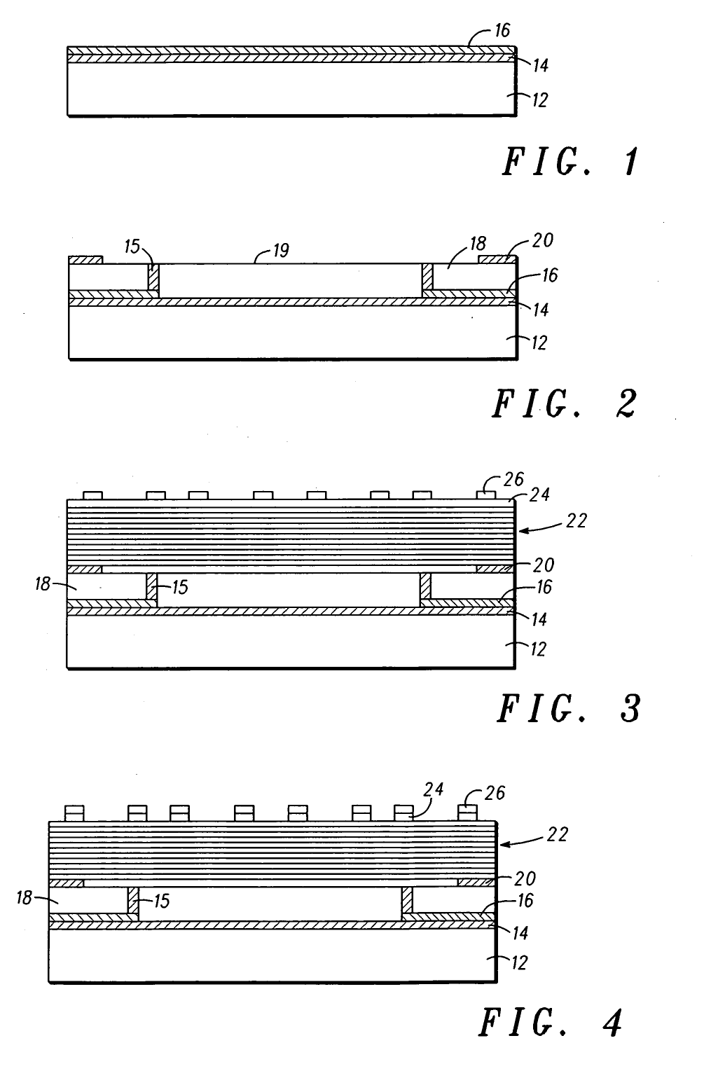

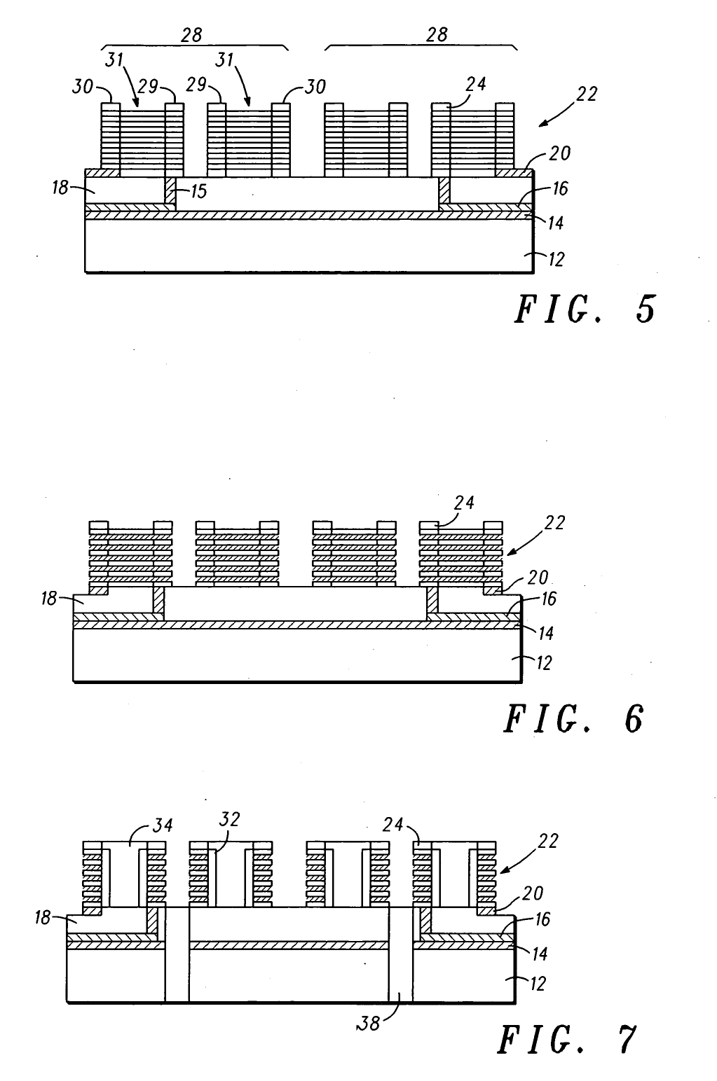

Referring to FIGS. 4-5, using a chemical etch, the dielectric layer 24 not protected by the resist layer 26, is removed. Then, after the resist layer 26 is removed, the multiple layers 22, not protected by the dielectric layer 24, are removed to form a pedestal 28 comprising a center anode 29 (inner section) and a concentric cathode 30 (outer section) surrounding, and separated by a cavity 31 from, the anode 29. The pedestal 28 preferably has a diameter of 10 to 100 microns. The distance between each pedestal 28 would be 10 to 100 microns, for example. Alternatively, the anode 29 and cathode 30 may be formed simultaneously by templated processes. In this process, the pillars will be fabricated using a photoresist or other template process followed by a multi-layer metal deposition around the pillars forming the structure shown in FIG. 5. Concentric as used herein means having a structure having a common center, but the anode, cavity, and cathode walls may take any form and are not to be limited to circles. For example, the pedestals 28 may alternatively be formed by etching orthogonal trenches.

The multiple layers 22 of alternating metals are then wet etched to remove one of the metals, leaving behind layers of the other metal having a void between each layer (FIG. 6). When removing the alternate metal layers, care must be taken in order to prevent collapse of the remaining layers. This may be accomplished, with proper design, by etching so that some undissolved metal portions of the layers remain. This may be accomplished by using alloys that are rich in the metal being removed so the etching does not remove the entire layer. Alternatively, this may also be accomplished by a patterning of the layers to be removed so that portions remain between each remaining layer. Either of these processes allow for exchange of gaseous reactants through the multiple layers. The metal remaining/removed preferably comprises gold/silver, but may also comprise, for example, nickel/iron or copper/nickel.

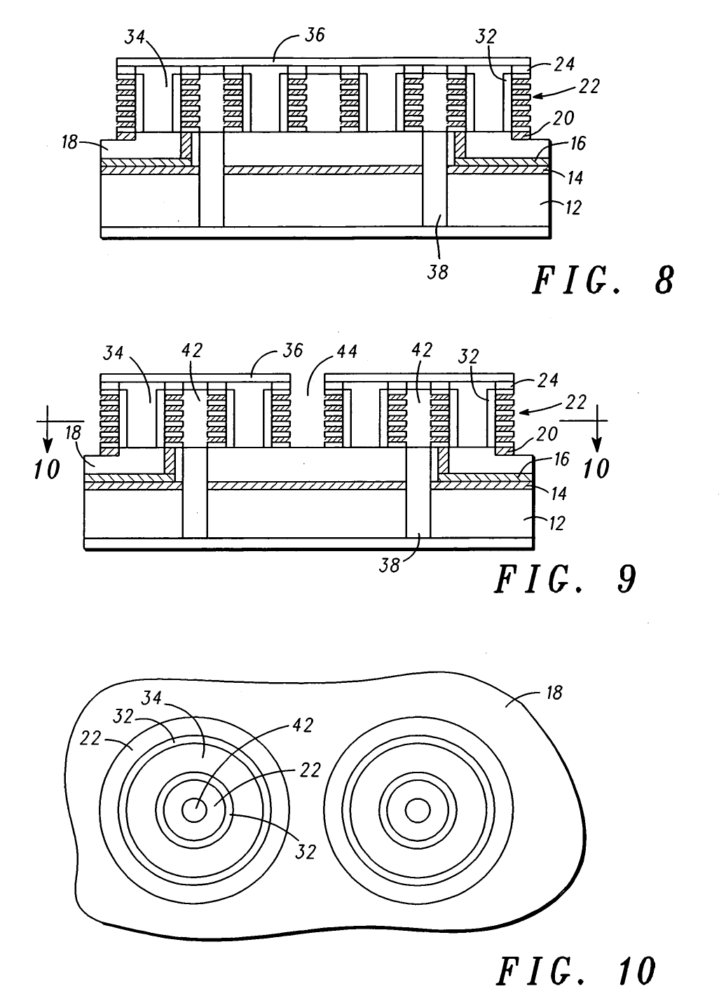

The side walls 32 are then coated with an electrocatalyst for anode and cathodic fuel cell reactions by wash coat or some other deposition methods such as CVD, PVD or electrochemical methods (FIG. 7). Then the layers 14 and 16 are etched down to the substrate 12 and an electrolyte material 34 is placed in the cavity 31 before a capping layer 36 is formed (FIG. 8) and patterned (FIG. 9) above the electrolyte material 34. Alternatively, the electrolyte material 34 may comprise, for example, perflurosulphonic acid (Nafion®), phosphoric acid, or an ionic liquid electrolyte. Perflurosulphonic acid has a very good ionic conductivity (0.1 S/cm) at room temperature when humidified. The electrolyte material also can be a proton conducting ionic liquids such as a mixture of bistrifluromethane sulfonyl and imidazole, ethylammoniumnitrate, methylammoniumnitrate of dimethylammoniumnitrate, a mixture of ethylammoniumnitrate and imidazole, a mixture of elthylammoniumhydrogensulphate and imidazole, flurosulphonic acid and trifluromethane sulphonic acid. In the case of liquid electrolyte, the cavity needs to be capped to protect the electrolyte from leaking out.

A via, or cavity, 38 is formed (FIG. 8) in the substrate 12 by chemical etching (wet or dry) methods. Then, using chemical or physical etching methods, the via 38 is extended through the layer 14 and 16 to the alternating multiple layers 22.

FIG. 10 illustrates a top view of adjacent fuel cells fabricated in the manner described in reference to FIG. 1-9. The silicon substrate 12, or the substrate containing the micro fuel cells, is positioned on a structure 40 for transporting hydrogen to the cavities 38. The structure 40 may comprise a cavity or series of cavities (e.g., tubes or passageways) formed in a ceramic material, for example. Hydrogen would then enter the hydrogen sections 42 of alternating multiple layers 22 above the cavities 38. Since sections 42 are capped with the dielectric layer 20, the hydrogen would stay within the sections 42. Oxidant sections 44 are open to the ambient air, allowing air (including oxygen) to enter oxidant sections 44.

After filling the cavity 34 with the electrolyte material, it will form a physical barrier between the anode (hydrogen feed) and cathode (air breathing) regions. Gas manifolds are built into the bottom packaging substrate to feed hydrogen gas to all the anode regions. Since it is capped on the top 36, it will be like a dead end anode feed configuration fuel cell.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A fuel cell comprising:
a substrate; and
a plurality of pedestals formed on the substrate, each pedestal comprising:
an outer section comprising a first plurality of conductive layers having a void between each of the layers;
an inner section comprising a second plurality of conductive layers having a void between each of the layers; and
an electrolyte positioned between the outer and inner sections.

2. The fuel cell of claim 1 wherein the porous pedestals are defined by trenches.

3. The fuel cell of claim 1 wherein the outer and inner sections comprise concentric circles.

4. The fuel cell of claim 3 wherein the inner section comprises an anode and the outer section comprises a cathode surrounding the anode.

5. The fuel cell of claim 1 further comprising a metal interconnects formed between the substrate and the inner sections for interconnecting the inner sections, and between the substrate and the cathodes for interconnecting the cathodes.

6. The fuel cell of claim 1 wherein the electrolyte comprises one of a proton conducting ionic liquid and perflurosulphonic acid.

7. The fuel cell of claim 1 wherein the surface area between the cathode and the electrolyte is larger than the surface area between the anode and the electrolyte.

8. The fuel cell of claim 1 wherein the void is of a size that allows for passage of gaseous reactants supplied to the anode or cathode, but inhibits passage of the electrolyte.

9. The fuel cell of claim 1 wherein the void comprises a thickness of between 0.1 to 10 microns.

10. The fuel cell of claim 1 wherein the void comprises a thickness of between 0.1 to 1 microns.

11. A method for fabricating a fuel cell, comprising:
depositing multiple layers of alternating metals over a substrate;
forming a plurality of pedestals in the multiple layers, each pedestal having a center anode portion and a concentric cathode portion separated by a concentric cavity;
etching at least one of the alternating metals, creating a void between the remaining layers;
filling the concentric cavity with an electrolyte; and
capping the center anode portion and the concentric cavity.

12. The method of claim 11 wherein the forming a plurality of pedestals step comprises defining the anode and cathode by etching the multiple layers to form a plurality of pedestals.

13. The method of claim 11 wherein the forming a plurality of pedestals step comprises defining the anode and cathode by applying a patterned photoresist prior to forming the multiple layers.

14. The method of claim 11 wherein the etching step includes leaving a portion of the one metal between the remaining layers.

15. The method of claim 11 wherein the etching step comprises patterning a photoresist prior to etching so a portion of the remaining layers extends to the adjacent layer.

16. The method of claim 11 wherein the step of filling the concentric cavity comprises filling the concentric cavity with an electrolyte comprises one of a proton conducting ionic liquid and perflurosulphonic acid.

17. A method for fabricating a fuel cell, comprising:
patterning a first metal layer over a substrate;
forming a first dielectric layer over the first metal layer;
patterning a second metal layer over the first dielectric;
forming vias within the first dielectric layer to the first metal layer;
forming multiple layers of alternating metals over the second metal layer and the substrate to form a plurality of pedestals
defining an anode and a cathode separated by a channel, wherein the anode contacts one of the via or the second metal layer, and the cathode contacts the other one of the via or the second metal layer;
etching at least one of the alternating metals, creating a void between the remaining layers;
coating the anode and cathode within the channel with an electrocatalyst;
filling the channels with an electrolyte;
capping the channels with an insulator; and
etching the substrate to provide a plurality of vias for supplying a fuel to the plurality of anodes.

18. The method of claim 17 wherein the forming multiple layers step comprises defining the anode and cathode by etching the multiple layers to form a plurality of pedestals.

19. The method of claim 17 wherein the forming multiple layers step comprises defining the anode and cathode by applying a patterned photoresist prior to forming the multiple layers.

20. The method of claim 17 wherein the step of filling the channels comprises filling the channels with an electrolyte comprises one of a proton conducting ionic liquid and perflurosulphonic acid.
